(19) United States
(12) Patent Application Publication
(10) Pub. No.: US 2015/0370262 A1
(43) Pub. Date: Dec. 24, 2015

(54) Liquid Supply Apparatus

(71) Applicant: MATSUI MFG. CO., LTD., Osaka-shi, Osaka (JP)

(72) Inventors: Kazunari Hanaoka, Hirakata-shi, Osaka (JP); Saiji Yamashita, Hirakata-shi, Osaka (JP); Motoharu Shimizu, Hirakata-shi, Osaka (JP)

(21) Appl. No.: 14/767,839

(22) PCT Filed: Feb. 27, 2013
(86) PCT No.: PCT/JP2013/055080

§ 371 Date: Aug. 13, 2015

(51) Int. Cl. G05D 7/06; H02P 27/06; F04D 13/06; G05D 16/20; F04D 1/00

(52) U.S. Cl. CPC G05D 7/0676; G05D 16/2066; F04D 1/00; F04D 13/06; H02P 27/06

(57) ABSTRACT

The liquid supply apparatus includes: an inverter converting the frequency of an alternating-current power supply; a pump including an electric motor driven by the inverter; a control part; and the like. The control part includes a physical quantity detection part, a medium control part, and the like. The physical quantity detection part detects a physical quantity concerning the output of the inverter. On the basis of the physical quantity detected by the physical quantity detection part, the medium control part controls at least one of the flow rate and the pressure of the liquid supplied by the pump.

### CROSS-REFERENCE TO RELATED APPLICATIONS

This application is the national phase under 35 U.S.C. §371 of PCT

International Application No. PCT/JP2013/055080 which has an International filing date of Feb. 27, 2013 and designated the United States of America.

### BACKGROUND

The present invention relates to a liquid supply apparatus provided with an inverter converting a frequency of an alternating-current power supply and with a pump including an electric motor driven by the inverter, and thereby supplying a liquid by using the pump.

### DESCRIPTION OF RELATED ART

In an injection molding machine performing injection molding of a molded article by using synthetic resin such as plastics, a mold tool is employed. The mold tool for injection molding includes: a cavity serving as a space part into which melted plastics is loaded; and a pipeline through which a liquid such as cooling water flows for the purpose of cooling and solidification of the melted plastics. Maintaining of the temperature of the mold tool accurately at an appropriate temperature is essentially important in improving the accuracy of the molded article.

Thus, a mold tool temperature adjustment apparatus is disclosed in which a liquid heated by a heater provided in a tank is circulated in the order of the tank, a heat exchanger, a mold tool, and the tank by a pump, then the temperature of the liquid having flowed out of the heat exchanger is measured by a temperature sensor, and then the temperature of the mold tool is adjusted on the basis of the measured value (see Japanese Patent Application Laid-Open No. H5-131455).

### SUMMARY

In accordance with the shape, the structure, or the like of the molded article, the shape or the structure of the cavity of the mold tool also varies. Thus, in order that a liquid of appropriate flow rate and pressure may be supplied to the mold tool, an appropriate pump such as a cascade pump and a volute pump was to be selected and used in accordance with the flow rate or the pressure to be supplied.

Further, in a case that an appropriate pump has been employed in accordance with the mold tool, when the mold tool employed in the molding machine is changed, the pressure loss in the mold tool varies and hence the flow rate of the liquid supplied to the mold tool also varies. Thus, in order that the pressure and the flow rate of the liquid supplied to the mold tool may be made appropriate, the pump was to be changed to another one.

Further, in a case that a cascade pump allowed to supply a liquid of relatively high pressure is employed, when the pressure increases owing to a pressure loss in the mold tool or the like, the electric current of the pump exceeds the rated current so that the operation of the pump is stopped owing to the over-current. In order that such a situation may be avoided, a bypass passage reducing the pressure is provided in the pipeline supplying the liquid. Then, when the pressure of the pipeline exceeds a fixed value, the bypass pipeline is operated so that the pump is protected.

Further, in a case that a volute pump allowed to supply a liquid of relatively high flow rate is employed, when the flow rate increases, the electric current of the pump exceeds the rated current so that the operation of the pump is stopped owing to the over-current. In order that such a situation may be avoided, a manual valve restricting the flow rate is to be provided in the pipeline and then the valve element of the valve is to be adjusted. However, a flowmeter is extremely expensive and hence the flowmeter is seldom installed actually. Thus, in practice, the actual flow rate of the liquid is not allowed to be recognized and hence the flow rate is restricted more than an appropriate extent by a manual valve.

The present invention has been devised in view of such situations. An object thereof is to provide a liquid supply apparatus in which the flow rate and the pressure of the liquid are allowed to be made appropriate.

A liquid supply apparatus according to the first aspect of the invention provided with an inverter converting a frequency of an alternating-current power supply and with a pump including an electric motor driven by the inverter, and thereby supplying a liquid by using the pump comprises: a physical quantity detection part detecting a physical quantity concerning an output of the inverter; and a medium control part, on the basis of the physical quantity detected by the physical quantity detection part, controlling at least one of a flow rate and a pressure of the liquid supplied by the pump.

In the liquid supply apparatus according to the second aspect of the invention, based on the first aspect of the invention, the physical quantity detection part is constructed such as to detect at least one of a torque, a torque current, and an electric power of the electric motor.

In the liquid supply apparatus according to the third aspect of the invention, based on the first or second aspect of the invention, the medium control part is constructed such as to control a frequency converted by the inverter and thereby control at least one of the flow rate and the pressure of the liquid supplied by the pump.

In the liquid supply apparatus according to the fourth aspect of the invention, based on any one of the first to third aspects of the invention, the medium control part is constructed such as to, on the basis of the physical quantity detected by the physical quantity detection part and pipe resistance characteristics indicating a relation between a frictional resistance and a flow rate of a fluid in a pipeline for supplying the fluid, control at least one of the flow rate and the pressure of the liquid supplied by the pump.

In the liquid supply apparatus according to the fifth aspect of the invention, based on the fourth aspect of the invention, the medium control part is constructed such as to control the frequency converted by the inverter, into a frequency specified by the pipe resistance characteristics and a torque curve of the electric motor and thereby control at least one of the flow rate and the pressure of the liquid supplied by the pump.

In the liquid supply apparatus according to the sixth aspect of the invention, based on the fourth or fifth aspect of the invention, the medium control part is constructed such as to, when the frequency converted by the inverter is higher than a frequency specified by the pipe resistance characteristics and the torque curve of the electric motor, lower the frequency of the inverter and thereby reduce the flow rate of the fluid.

In the liquid supply apparatus according to the seventh aspect of the invention, based on any one of the fourth to sixth aspects of the invention, the medium control part is constructed such as to, when the frequency converted by the inverter is lower than a frequency specified by the pipe resistance characteristics and the torque curve of the electric motor, raise the frequency of the inverter and thereby increase the flow rate or the pressure of the fluid.

In the liquid supply apparatus according to the eighth aspect of the invention, based on any one of the fourth to seventh aspects of the invention, the medium control part is constructed such as to, when the torque or the torque current detected by the physical quantity detection part is higher than a given threshold, lower the frequency of the inverter to a frequency specified by the pipe resistance characteristics and the torque curve of the electric motor and thereby reduce the pressure of the fluid.

The liquid supply apparatus according to the ninth aspect of the invention, based on any one of the first to eighth aspects of the invention, comprises a flow rate setting part setting up a flow rate of the liquid supplied by the pump. The medium control part is constructed such as to adjust the frequency converted by the inverter, into a frequency specified by the flow rate set up by the flow rate setting part and the torque curve of the electric motor and thereby control the pressure of the fluid.

The liquid supply apparatus according to the tenth aspect of the invention, based on any one of the first to ninth aspects of the invention, comprises a pressure setting part setting up a pressure of the liquid supplied by the pump. The medium control part is constructed such as to adjust the frequency converted by the inverter, into a frequency specified by the pressure set up by the pressure setting part and the torque curve of the electric motor and thereby control the flow rate of the fluid.

The liquid supply apparatus according to the eleventh aspect of the invention, based on any one of the first to tenth aspects of the invention, comprises: a pressure calculation part, on the basis of a relation set forth in advance between the pressure of the liquid and the torque or the torque current of the electric motor and on the basis of the torque or the torque current of the electric motor detected by the physical quantity detection part, calculating the pressure of the liquid supplied by the pump; and a pressure display part displaying the pressure calculated by the pressure calculation part.

The liquid supply apparatus according to the twelfth aspect of the invention, based on the eleventh aspect of the invention, comprises a notification part, when the pressure calculated by the pressure calculation part falls outside a given pressure range, notifying this situation.

The liquid supply apparatus according to the thirteen aspect of the invention, based on any one of the first to eleventh aspects of the invention, comprises: a flow rate calculation part, on the basis of a relation set forth in advance between the flow rate of the liquid and the frequency converted by the inverter and on the basis of the frequency converted by the inverter, calculating a flow rate of the liquid supplied by the pump; and a flow rate display part displaying the flow rate calculated by the flow rate calculation part.

The liquid supply apparatus according to the fourteenth aspect of the invention, based on the thirteenth aspect of the invention, comprises a notification part, when the flow rate calculated by the flow rate calculation part falls outside a given flow rate range, notifying this situation.

In the first aspect of the invention, the physical quantity detection part detects the physical quantity concerning the output of the inverter. For example, the physical quantity concerning the output of the inverter is the torque of the electric motor. Alternatively, the torque current, the load current, the electric motor output power, or the like allowed to be converted into the torque of the electric motor may be adopted. The physical quantity detection part may be provided in the inside of the inverter. Alternatively, a sensor may be provided on the electric motor side so that detection may be performed. On the basis of the physical quantity detected by the physical quantity detection part, the medium control part controls at least one of the flow rate and the pressure of the liquid supplied by the pump. The flow rate of the liquid is in relation of being proportional to the revolution rate of the revolving shaft of the electric motor, that is, the frequency converted by the inverter. Further, the pressure of the liquid is in relation of being proportional to the torque of the electric motor. For example, when the flow rate of the liquid is to be increased or decreased, the frequency of the inverter is controlled such as to be raised or lowered. Further, when the pressure of the liquid is to be increased or decreased, the frequency of the inverter is controlled such that the torque of the electric motor is increased or decreased. By virtue of this, the flow rate or the pressure of the liquid is brought into an appropriate value.

In the second aspect of the invention, the physical quantity detection part is constructed such as to detect at least one of the torque, the torque current, and the electric power (the output power) of the electric motor. By virtue of this, feedback is allowed to be performed for controlling the frequency converted by the inverter on the basis of the torque, the torque current, or the electric power of the electric motor detected by the physical quantity detection part.

In the third aspect of the invention, the medium control part is constructed such as to control the frequency converted by the inverter and thereby control at least one of the flow rate and the pressure of the liquid supplied by the pump. The revolving speed of the blades of the pump, that is, the revolving speed of the revolving shaft of the electric motor, and the flow rate of the liquid supplied by the pump have a relation to each other that the flow rate is proportional to the revolving speed. Further, the revolving speed of the revolving shaft of the electric motor and the pressure of the liquid supplied by the pump have a relation to each other that the pressure is proportional to the square of the revolving speed. The revolving speed of the revolving shaft of the electric motor is proportional to the frequency converted by the inverter and the pressure of the liquid is proportional to the torque or the torque current of the electric motor. The inverter-controlled electric motor has characteristics between the frequency of the inverter and the torque of the electric motor expressed by a torque curve of the electric motor. Thus, when the frequency of the inverter is controlled, the flow rate of the liquid is allowed to be controlled. At the same time, when the torque of the electric motor is controlled along the torque curve, the pressure of the liquid is allowed to be controlled.

In the fourth aspect of the invention, the medium control part is constructed such as to, on the basis of the physical quantity detected by the physical quantity detection part and pipe resistance characteristics indicating the relation between the frictional resistance and the flow rate of the fluid in the pipeline for supplying the fluid, control at least one of the flow rate and the pressure of the liquid supplied by the pump. The pipe resistance characteristics indicate the relation between the frictional resistance and the flow rate of the liquid flowing through the pipeline, where the frictional resistance of the liquid is proportional to the square of the flow rate. When the pressure of the liquid increases, the frictional resistance also increases. That is, the relation between the flow rate and the pressure of the liquid flowing through the pipeline varies depending on the pipe resistance characteristics of the pipeline. Thus, regardless of what kind of characteristics the pipe resistance characteristics of the pipeline are, further, even in a case that what kind of characteristics the pipe resistance characteristics are is not allowed to be recognized specifically, when the frequency of the inverter is controlled, the flow rate of the liquid is allowed to be controlled and, at the same time, the pressure of the liquid is also allowed to be controlled on the basis of the pipe resistance characteristics.

In the fifth aspect of the invention, the medium control part is constructed such as to control the frequency converted by the inverter, into a frequency specified by the pipe resistance characteristics and a torque curve of the electric motor and thereby control at least one of the flow rate and the pressure of the liquid supplied by the pump. The relation between the flow rate and the pressure of the liquid flowing through the pipeline varies depending on the pipe resistance characteristics of the pipeline. On the other hand, the torque of the inverter-controlled electric motor varies in response to the frequency of the inverter depending on the torque curve of the electric motor. The torque of the electric motor is proportional to the pressure of the liquid. For example, the frequency specified by the torque curve of the electric motor and the pipe resistance characteristics indicates a frequency in which the pressure and the flow rate of the liquid satisfy the pipe resistance characteristics and in which the frequency of the inverter and the torque of the electric motor fall on the torque curve to be used. That is, regardless of what kind of characteristics the pipe resistance characteristics of the pipeline are, further, even in a case that what kind of characteristics the pipe resistance characteristics are is not allowed to be recognized specifically, when the frequency converted by the inverter is adjusted, the flow rate and the pressure of the liquid are allowed to be changed on the basis of the pipe resistance characteristics and, at the same time, the torque of the electric motor is allowed to fall on the torque curve. Thus, the electric motor is allowed to be used within the range of use at a highest capability. Then, even when the state of the load such as a mold tool varies, the pressure and the flow rate of the liquid are allowed to be supplied at a highest capability of the electric motor.

In the sixth aspect of the invention, the medium control part is constructed such as to, when the frequency converted by the inverter is higher than a frequency specified by the pipe resistance characteristics and the torque curve of the electric motor, lower the frequency of the inverter and thereby reduce the flow rate of the fluid. When the state of the load such as a mold tool varies so that the flow rate of the liquid increases as an example, the pressure and the flow rate of the liquid satisfy the pipe resistance characteristics but the frequency of the inverter and the torque of the electric motor exceed the torque curve to be used. Thus, in a state that the pressure and the flow rate of the liquid satisfy the pipe resistance characteristics, the frequency of the inverter is lowered and thereby the flow rate of the fluid is reduced so that control is performed such that the frequency of the inverter and the torque of the electric motor may fall on the torque curve to be used. Thus, in the conventional art, the flow rate of the pipeline was not allowed to be recognized. Thus, the use was to be performed in a state that the valve of the pipeline was throttled and hence the pipe resistance was increased so that the flow rate was reduced more than an appropriate extent. However, according to the above-described configuration, even when the state of the load such as a mold tool varies, the flow rate of the liquid is allowed to be controlled at a highest capability of the electric motor. Further, also the adjustment valve for adjusting the flow rate of the pipeline may be not provided.

In the seventh aspect of the invention, the medium control part is constructed such as to, when the frequency converted by the inverter is lower than a frequency specified by the pipe resistance characteristics and the torque curve of the electric motor, raise the frequency of the inverter and thereby increase the flow rate or the pressure of the fluid. When the state of the load such as a mold tool varies so that the flow rate of the liquid decreases as an example, the pressure and the flow rate of the liquid satisfy the pipe resistance characteristics but the frequency of the inverter and the torque of the electric motor go below the torque curve to be used. Thus, in a state that the pressure and the flow rate of the liquid satisfy the pipe resistance characteristics, the frequency of the inverter is raised and thereby the flow rate of the fluid is increased so that control is performed such that the frequency of the inverter and the torque of the electric motor may fall on the torque curve to be used. Further, when the torque of the electric motor is increased, the pressure of the liquid is allowed to be increased. By virtue of this, even when the state of the load such as a mold tool varies, the flow rate and the pressure of the liquid are allowed to be increased at a highest capability of the electric motor.

In the eighth aspect of the invention, the medium control part is constructed such as to, when the torque or the torque current detected by the physical quantity detection part is higher than a given threshold, lower the frequency of the inverter to a frequency specified by the pipe resistance characteristics and the torque curve of the electric motor and thereby reduce the pressure of the fluid. When the state of the load such as a mold tool varies so that the pressure of the liquid increases as an example, the pressure and the flow rate of the liquid satisfy the pipe resistance characteristics but the frequency of the inverter and the torque of the electric motor exceed the torque curve to be used. Thus, in a state that the pressure and the flow rate of the liquid satisfy the pipe resistance characteristics, the frequency of the inverter is lowered and thereby the flow rate of the liquid is reduced so that the pressure of the liquid is reduced on the basis of the pipe resistance characteristics. Since the pressure of the liquid decreases, the torque of the electric motor also decreases. Thus, control is performed such that the frequency of the inverter and the torque of the electric motor may fall on the torque curve to be used. Thus, in the conventional art, a bypass passage (a bypass route) was to be provided that, when the state of the load such as a mold tool varies, releases the pressure in order to avoid a situation that the pressure in the pipeline becomes of high pressure. However, according to the above-described configuration, even when the state of the load such as a mold tool varies, a situation is avoided that the pressure of the liquid becomes excessively high. Thus, the bypass passage may be not provided.

In the ninth aspect of the invention, the medium control part is constructed such as to adjust the frequency converted by the inverter, into a frequency specified by the flow rate set up by the flow rate setting part and the torque curve of the electric motor and thereby control the pressure of the fluid. For example, when the state of the load such as a mold tool varies so that the flow rate of the liquid increases as an example, in order that the flow rate may be reduced to the set-up flow rate, the frequency of the inverter is lowered so that the flow rate of the liquid is brought into the set-up value along the torque curve of the electric motor. By virtue of this, even when the state of the load such as a mold tool varies, control is allowed to be performed such that the flow rate is always maintained at the set-up flow rate. Further, the torque of the electric motor increases along the torque curve. Thus, when the flow rate of the liquid is reduced to the set-up value, the pressure of the liquid is allowed to be increased.

In the tenth aspect of the invention, the medium control part is constructed such as to adjust the frequency converted by the inverter, into a frequency specified by the pressure set up by the pressure setting part and the torque curve of the electric motor and thereby control the flow rate of the fluid. For example, when the state of the load such as a mold tool varies so that the pressure of the liquid increases as an example, in order that the pressure may be reduced to the set-up pressure, the frequency of the inverter is raised so that the torque of the electric motor is reduced along the torque curve of the electric motor and thereby the pressure of the liquid is brought into the set-up value. By virtue of this, even when the state of the load such as a mold tool varies, control is allowed to be performed such that the pressure is always maintained at the set-up pressure. Further, since the frequency of the inverter is raised, when the pressure of the liquid is reduced to the set-up value, the flow rate of the liquid is allowed to be increased.

In the eleventh aspect of the invention, on the basis of the relation set forth in advance between the pressure of the liquid and the torque or the torque current of the electric motor and on the basis of the torque or the torque current of the electric motor detected by the physical quantity detection part, the pressure calculation part calculates the pressure of the liquid supplied by the pump. As for the relation between the pressure of the liquid and the torque or the torque current of the electric motor, the pressure and the torque or the torque current at a plurality of points on the relational expression indicating the relation between the pressure of the liquid and the torque or the torque current of the electric motor may be stored in correspondence to each other and then the pressure may be calculated with reference to the correspondence. Alternatively, the pressure may be calculated by an arithmetic operation based on the relational expression indicating the relation between the pressure of the liquid and the torque or the torque current of the electric motor. The pressure display part displays the calculated pressure. By virtue of this, the pressure gage may be not provided in the pipeline through which the liquid flows. Further, an error in pressure measurement caused by use of a pressure gage is avoided and hence the pressure of the liquid is allowed to be acquired accurately.

In the twelfth aspect of the invention, when the pressure calculated by the pressure calculation part falls outside a given pressure range, the notification part notifies this situation. For example, when the pressure of the liquid exceeds the upper limit or goes lower than the lower limit, this situation is allowed to be notified by voice or display.

In the thirteenth aspect of the invention, on the basis of the relation set forth in advance between the flow rate of the liquid and the frequency converted by the inverter and on the basis of the frequency having been converted by the inverter, the flow rate calculation part calculates the flow rate of the liquid supplied by the pump. As for the relation between the flow rate of the liquid and the frequency converted by the inverter, the flow rate and the frequency of the inverter at a plurality of points on the relational expression indicating the relation between the flow rate of the liquid and the frequency converted by the inverter may be stored in correspondence to each other and then the flow rate may be calculated with reference to the correspondence. Alternatively, the flow rate may be calculated by an arithmetic operation based on the relational expression indicating the relation between the flow rate of the liquid and the frequency of the inverter. The flow rate display part displays the calculated flow rate. By virtue of this, even when an expensive flow rate is not provided, the flow rate of the liquid is allowed to be acquired accurately.

In the fourteenth aspect of the invention, when the flow rate calculated by the flow rate calculation part falls outside a given flow rate range, the notification part notifies this situation. For example, when the flow rate of the liquid exceeds the upper limit or goes lower than the lower limit, this situation is allowed to be notified by voice or display.

According to the present invention, the flow rate or the pressure of the liquid is allowed to be brought into an appropriate value.

The above and further objects and features of the invention will more fully be apparent from the following detailed description with accompanying drawings.

### BRIEF DESCRIPTION OF THE DRAWINGS

FIG. 1 is an explanation diagram illustrating an example of configuration of a liquid supply system including a liquid supply apparatus of the present embodiment.

FIG. 2 is a schematic diagram illustrating an example of characteristics indicating a relation between the flow rate and the pressure of water supplied by a pump and the revolution rate of the revolving shaft of a motor.

FIG. 3 is an explanation diagram illustrating an example of output characteristics of an inverter-controlled motor of the present embodiment.

FIG. 4 is a schematic diagram illustrating an example of pipe resistance characteristics of a pipe extending from a pump to a mold tool.

FIG. 5 is an explanation diagram illustrating a first example of flow rate control by a liquid supply apparatus of the present embodiment.

FIG. 6 is an explanation diagram illustrating a second example of flow rate control by a liquid supply apparatus of the present embodiment.

FIG. 7 is an explanation diagram illustrating a first example of pressure control by a liquid supply apparatus of the present embodiment.

FIG. 8 is an explanation diagram illustrating a second example of pressure control by a liquid supply apparatus of the present embodiment.

FIG. 9 is an explanation diagram illustrating an example of flow rate setting by a liquid supply apparatus of the present embodiment.

FIG. 10 is an explanation diagram illustrating an example of pressure setting by a liquid supply apparatus of the present embodiment.

FIG. 11 is an explanation diagram illustrating an example of a case that both of the pressure and the flow rate are set up in a liquid supply apparatus of the present embodiment.

FIG. 12 is an explanation diagram illustrating an example of a relation between the torque ratio of a motor and the pressure of water supplied by a pump.

FIG. 13 is an explanation diagram illustrating an example of the frequency of an inverter and the flow rate of water supplied by a pump.

FIG. 14 is an explanation diagram illustrating another example of configuration of a liquid supply system including a liquid supply apparatus of the present embodiment.

### DETAILED DESCRIPTION

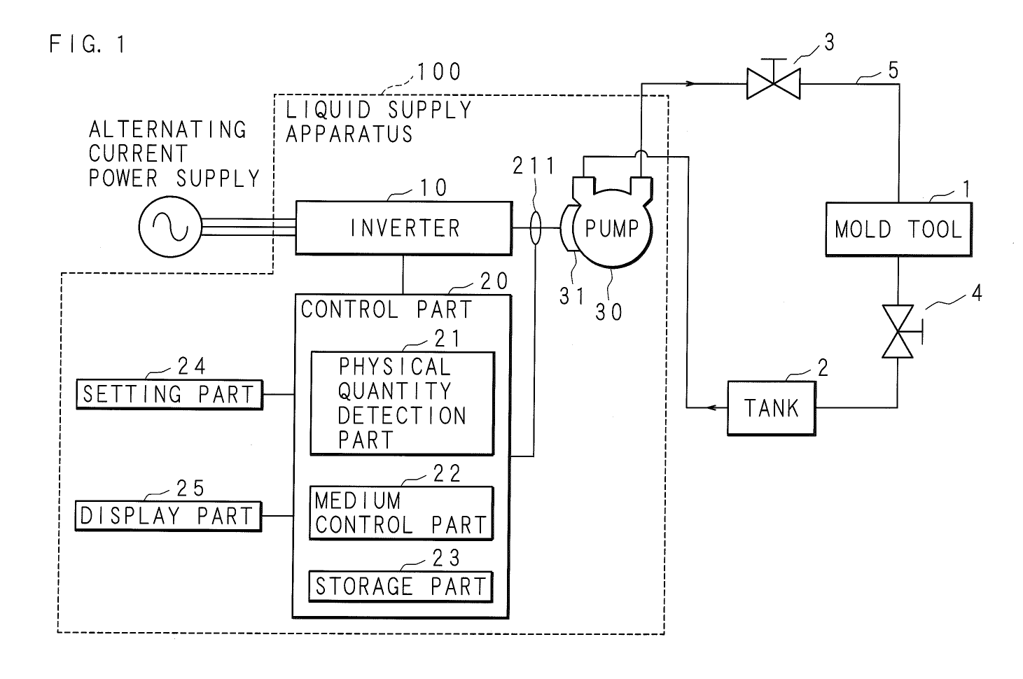

Hereinafter, the present invention is described below with reference to the drawings illustrating embodiments thereof. FIG. 1 is an explanation diagram illustrating an example of configuration of a liquid supply system including a liquid supply apparatus 100 of the present embodiment. As illustrated in FIG. 1, the liquid supply apparatus 100 includes an inverter 10, a control part 20, a pump 30, a setting part 24, a display part 25, and the like. The control part 20 includes a physical quantity detection part 21, a medium control part 22, a storage part 23 and the like. The pump 30 includes a motor 31 serving as an electric motor.

A pipe 5 for sending the liquid from the pump 30 to a mold tool 1 and a pipe 5 for returning the liquid from the mold tool 1 to the pump 30 are connected between the pump 30 and the mold tool 1 to which a liquid is supplied. A medium sending valve 3 is inserted in the pipe 5 for sending the liquid from the pump 30 to the mold tool 1. Further, a medium returning valve 4 and a tank 2 are inserted in the pipe 5 for returning the liquid from the mold tool 1 to the pump 30. Here, the tank 2 is connected to a pipe for water supply and a pipe for water drainage which are not illustrated.

The tank 2 includes a heater, a heat exchanger (not illustrated), and the like and is allowed to set the temperature of the liquid returned from the mold tool 1 into a given temperature. The present embodiment is described for an example that the device to which the liquid is supplied is a mold tool. However, the device to which the liquid is supplied is not limited to a mold tool and may be a heat exchanger in which the flow rate and the pressure of the liquid fluctuate or, alternatively, other devices.

In the present embodiment, the mold tool 1 has a wide range of variety from a relatively small mold tool to a relatively large mold tool. For example, a small mold tool is employed for a molded article having relatively small dimensions but a complicated shape. In the case of a small mold tool, also the pipeline provided in the mold tool becomes complicated and a liquid of high pressure is to be supplied. On the other hand, a large mold tool is employed for a molded article having large dimensions or shape. In the case of a large mold tool, in order that the temperature of the mold tool may be controlled to an appropriate temperature, a liquid of high flow rate is to be supplied. Further, as the liquid, water, oil, or the like may be employed. In the following description, water is premised to be employed as an example of the liquid.

The inverter 10 converts the frequency (the basic frequency) of an alternating-current power supply supplied from a commercial power source such as 50 Hz or 60 Hz and then outputs the alternating voltage having the converted frequency to the motor 31 of the pump 30.

In the pump 30, an impeller is revolved at a high speed in the inside of a casing (a container) by revolution of the motor 31 so that water of desired pressure and flow rate is supplied by utilizing a centrifugal force acting on the water (the liquid). In the present embodiment, pumps employable as the pump 30 include: a volute pump having a high flow rate (e.g., a flow rate of approximately 90 L/min or higher); a cascade pump having a relatively low flow rate but allowed to supply water of high pressure; and the like.

The physical quantity detection part 21 detects a physical quantity concerning the output of the inverter 10. For example, the physical quantity concerning the output of the inverter 10 is the torque, the torque current, or the output power (the electric power) of the motor 31. Here, the torque may be a torque ratio (a non-dimensionalized value) obtained by dividing the actual torque by the rated torque (a fixed value specific to the motor 31). In the present embodiment, quantities employable as the torque of the motor 31 may include also the torque current, the load current, the motor 31 output power, and the like allowed to be converted into the torque of the motor 31. That is, it is premised that quantities employable as the torque of the motor 31 include the torque of the motor 31 as well as the torque current and the load current of the motor 31 and the output power of the motor 31.

The physical quantity detection part 21 is allowed to acquire the torque of the motor 31 from the output current outputted to the motor 31. More specifically, since the output current of the inverter 10 is the total of a torque current (the active current) component corresponding to the torque of the motor 31 and a reactive current component not contributing to the torque, the torque of the motor 31 is allowed to be acquired on the basis of the torque current obtained by subtracting the reactive current component from the output current.

When the physical quantity detection part 21 detects at least one of the torque, the torque current, and the electric power (the output power) of the motor 31, feedback is allowed to be performed for controlling the frequency converted by the inverter 10.

Here, the physical quantity detection part 21 may have a configuration that a sensor in the inside of the inverter 10 (not illustrated) detects the physical quantity or, alternatively, a configuration that a sensor 211 is provided between the inverter 10 and the motor 31 and then the sensor 211 provided in the outside of the inverter 10 detects the physical quantity.

The relation between the frequency converted by the inverter 10 and the revolution rate (also referred to as a “revolving speed”) of the revolving shaft of the motor 31 is expressed as Vf=120×F/S. Here, Vf indicates the revolution rate of the revolving shaft of the motor 31, S indicates the number of poles of the motor 31, and F indicates the frequency of the inverter 10. For example, when the motor 31 has four poles and the frequency F of the inverter 10 is 50 Hz, the revolution rate Vf of the revolving shaft of the motor 31 becomes 1500 rpm. When the frequency F of the inverter 10 is 60 Hz, the revolution rate Vf of the revolving shaft of the motor 31 becomes 1800 rpm.

On the basis of the physical quantity detected by the physical quantity detection part 21, the medium control part 22 controls at least one of the flow rate and the pressure of the water supplied by the pump 30.

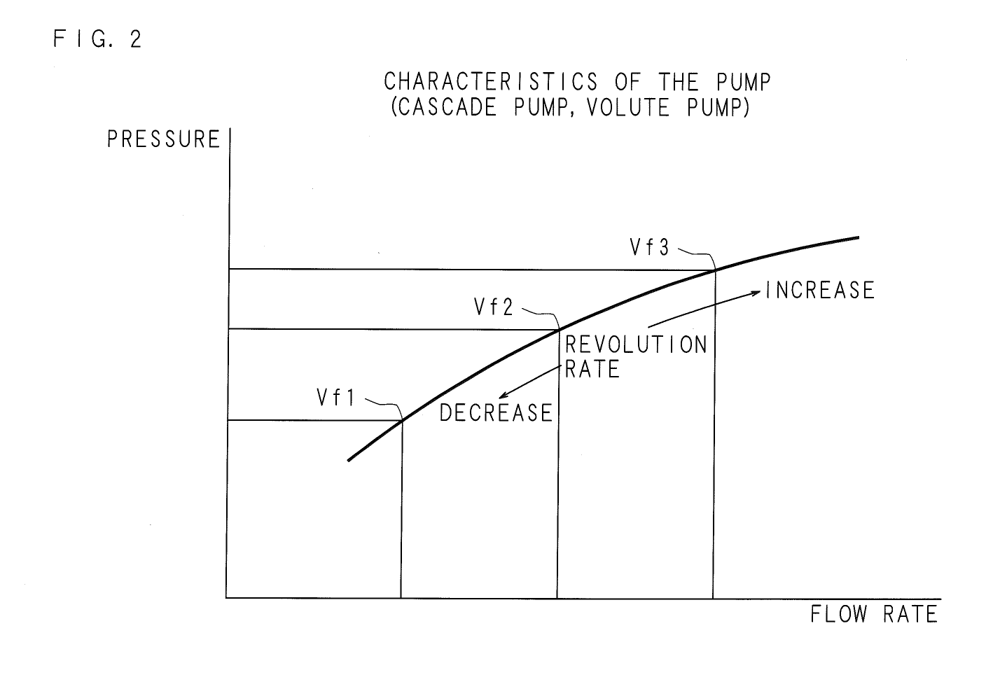

FIG. 2 is a schematic diagram illustrating an example of characteristics indicating the relation between the flow rate and the pressure of water supplied by the pump 30 and the revolution rate of the revolving shaft of the motor 31. The characteristics illustrated in

FIG. 2 are characteristics of the pump alone. The cascade pump and the volute pump have similar characteristics to each other.

The flow rate Q of the water supplied by the pump 30 is in relation of being proportional to the revolution rate of the revolving shaft of the motor 31, that is, the frequency converted by the inverter 10. That is, the revolution rate Vf of the revolving shaft of the motor 31 and the flow rate Q of the water supplied by the pump 30 have a relation to each other that the flow rate Q is proportional to the revolution rate Vf (Q∝Vf). For example, when the frequency of the inverter 10 is raised so that the revolution rate of the revolving shaft of the motor 31 increases along Vf1, Vf2, and Vf3, the flow rate Q also increases.

Further, the pressure P of the water supplied by the pump 30 is in relation of being proportional to the revolution rate of the revolving shaft of the motor 31, that is, the frequency converted by the inverter 10. More specifically, the revolution rate Vf of the revolving shaft of the motor 31 and the pressure P of the water supplied by the pump 30 have a relation to each other that the pressure P is proportional to the square of the revolution rate Vf (P ∝Vf²). For example, when the frequency of the inverter 10 is raised so that the revolution rate of the revolving shaft of the motor 31 increases along Vf1, Vf2, and Vf3, the pressure also increases. Further, the pressure P of the liquid and the torque T of the motor 31 have a relation to each other that the pressure P is proportional to torque T (P∝T).

Thus, when the flow rate of the liquid is to be increased or decreased, the frequency of the inverter 10 is controlled such as to be raised or lowered. Further, when the pressure of the liquid is to be increased or decreased, the frequency of the inverter 10 is controlled such that the torque of the motor 31 is increased or decreased. By virtue of this, the flow rate or the pressure of the liquid is brought into an appropriate value.

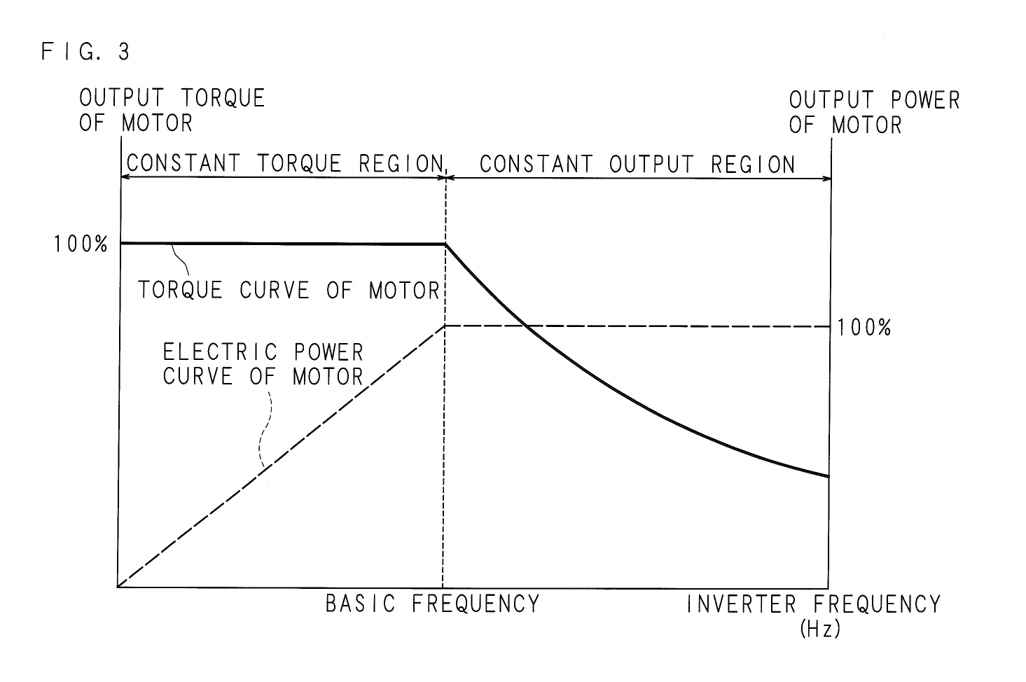

FIG. 3 is an explanation diagram illustrating an example of output characteristics of an inverter-controlled motor of the present embodiment. In FIG. 3, the horizontal axis indicates the frequency of the inverter 10 and the vertical axis indicates the torque (the output torque) and the output power of the motor 31. As illustrated in FIG. 3, the output characteristics of the motor 31 vary at a boundary where the frequency of the inverter 10 is the basic frequency (e.g., 50 Hz or 60 Hz). At or below the basic frequency, constant torque characteristics are realized and, at or above the base revolution rate, constant output (constant electric power) characteristics are realized.

In FIG. 3, as the torque curve (the torque characteristics) of the motor 31 indicated by a solid line, the torque of the motor 31 remains constant in the constant torque region and, in the constant output region, gradually decreases as the frequency of the inverter 10 is raised. On the torque curve of the motor 31 in the constant output region, the output power of the motor remains constant.

Further, in FIG. 3, as the electric power curve (the electric power characteristics) of the motor 31 indicated by a dashed line, in the constant torque region, the electric power of the motor 31 gradually increases as the frequency of the inverter 10 is raised. Then, in the constant output region, the electric power of the motor 31 remains constant. In the constant output region, the torque of the motor 31 gradually decreases as the frequency of the inverter 10 is raised. On the electric power curve of the motor 31 in the constant torque region, the torque of the motor 31 remains constant.

The medium control part 22 is allowed to control the frequency converted by the inverter 10 and thereby control at least one of the flow rate and the pressure of the water supplied by the pump 30. The inverter-controlled motor 31 has characteristics between the frequency of the inverter 10 and the torque of the motor 31 expressed by a torque curve of the motor 31 illustrated in FIG. 3. Thus, when the frequency of the inverter 10 is controlled, the flow rate of the water is allowed to be controlled. At the same time, when the torque of the motor 31 is controlled along the torque curve, the pressure of the water is allowed to be controlled.

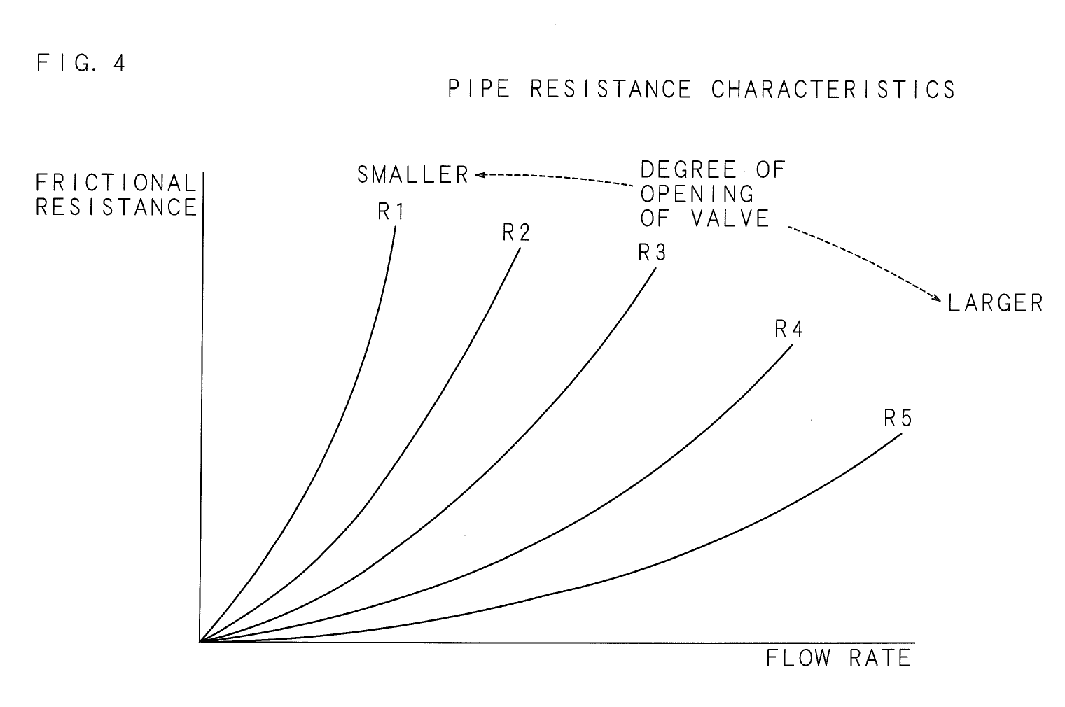

FIG. 4 is a schematic diagram illustrating an example of pipe resistance characteristics of the pipe extending from the pump to the mold tool. In FIG. 4, the horizontal axis indicates the flow rate of water and the vertical axis indicates the frictional resistance of water. Here, in FIG. 4, for simplicity, the actual pump head indicating the height from the suctioning water surface is not illustrated. The pipe resistance characteristics indicate the relation between the frictional resistance and the flow rate of the liquid flowing through the pipeline, where the frictional resistance of the liquid is proportional to the square of the flow rate. When the pressure of the liquid increases, the frictional resistance also increases. Thus, the relation between the flow rate and the pressure of the liquid flowing through the pipeline varies depending on the pipe resistance characteristics of the pipeline.

Further, as an example, in a case that a valve is provided in the pipe and then the degree of opening of the valve is adjusted, when the degree of opening of the valve is made smaller, the frictional resistance relative to the flow rate of the pipe resistance characteristics becomes higher (the situation approaches the curve indicated by symbol R1 in FIG. 4). Further, the degree of opening of the valve is made larger, the flow rate becomes higher (the situation approaches the curve indicated by symbol R5 in FIG. 4).

Here, in contrast to the present embodiment, in the case of the conventional art, a manual valve was to be provided in the pipe and then the valve was to be throttled (the degree of opening was remained at a fixed level or smaller) so that the flow rate of the water flowing through the pipe was to be restricted. This is because a situation was to be avoided that in a case that a volute pump allowed to supply a liquid of relatively high flow rate is employed, when the flow rate increases, the electric current of the pump exceeds the rated current so that the operation of the pump is stopped owing to the over-current. Further, a flowmeter is extremely expensive and hence the flowmeter is seldom installed actually. Thus, in practice, the actual flow rate of the liquid is not allowed to be recognized and hence, for the purpose of achieving the safety, the flow rate is to be restricted more than an appropriate extent by the manual valve.

In the present embodiment, on the basis of the physical quantity (e.g., the torque of the motor 31) detected by the physical quantity detection part 21 and the pipe resistance characteristics of the water in the pipe 5, the medium control part 22 controls at least one of the flow rate and the pressure of the liquid supplied by the pump 30. As illustrated in FIG. 4, the relation between the flow rate and the pressure of the water flowing through the pipe 5 varies depending on the pipe resistance characteristics of the pipe 5. Thus, regardless of what kind of characteristics the pipe resistance characteristics of the pipe 5 are, further, even in a case that what kind of characteristics the pipe resistance characteristics are is not allowed to be recognized specifically, when the frequency of the inverter 10 is controlled, the flow rate of the water is allowed to be controlled and, at the same time, the pressure of the water is also allowed to be controlled on the basis of the pipe resistance characteristics.

Further, the medium control part 22 controls the frequency converted by the inverter 10, into a frequency specified by the pipe resistance characteristics and the torque curve of the motor 31 and thereby control at least one of the flow rate and the pressure of the water supplied by the pump 30. As illustrated in FIG. 4, the relation between the flow rate and the pressure of water flowing through a pipe varies depending on the pipe resistance characteristics of the pipe. On the other hand, as illustrated in FIG. 3, the torque of the inverter-controlled motor 31 varies in response to the frequency of the inverter 10 depending on the torque curve of the motor 31. Further, the torque of the motor 31 is proportional to the pressure of the water supplied by the pump 30.

For example, the frequency specified by the torque curve of the motor 31 and the pipe resistance characteristics indicates a frequency in which the pressure and the flow rate of the water satisfy the pipe resistance characteristics and in which the frequency of the inverter 10 and the torque of the motor 31 fall on the torque curve to be used.

That is, regardless of what kind of characteristics the pipe resistance characteristics of the pipe 5 are, further, even in a case that what kind of characteristics the pipe resistance characteristics are is not allowed to be recognized specifically, when the frequency converted by the inverter 10 is adjusted, the flow rate and the pressure of the water supplied by the pump 30 are allowed to be changed on the basis of the pipe resistance characteristics and, at the same time, the torque of the motor 31 is allowed to fall on the torque curve. Thus, the motor 31 is allowed to be used within the range of use at a highest capability. Thus, even when the state of the load such as the mold tool varies, the pressure and the flow rate of the water are allowed to be controlled at a highest capability of the motor 31.

A control method for the flow rate and the pressure of water in the liquid supply apparatus 100 of the present embodiment is described below in detail.

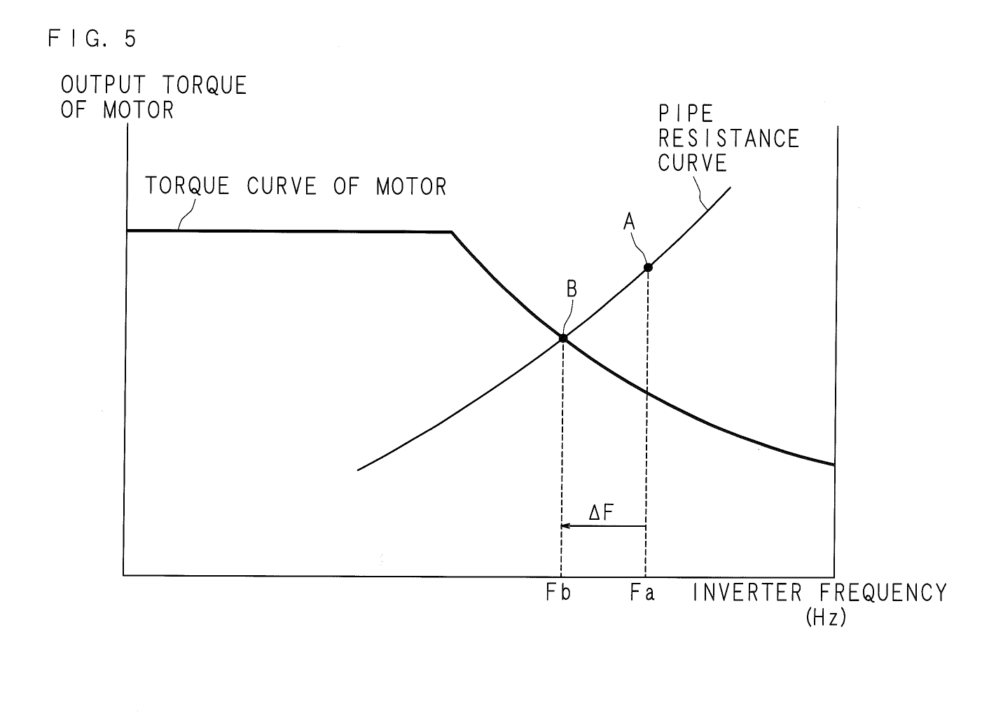

FIG. 5 is an explanation diagram illustrating a first example of flow rate control by the liquid supply apparatus 100 of the present embodiment. In FIG. 5, the horizontal axis indicates the frequency of the inverter 10 and the vertical axis indicates the output torque (the torque) of the motor 31. For example, the torque curve of the motor illustrated in FIG. 5 is a torque curve in which the motor 31 is allowed to be used at a highest capability (e.g., 100% of the rated performance) within the range of use. Here, the torque curve of the motor 31 is not limited to the torque curve in which a highest capability is achieved. That is, 95%, 90%, or the like of the rated performance may be employed. Alternatively, 105%, 110%, or the like exceeding the rated performance may be employed. Further, the employed pipe resistance curve is that illustrated in FIG. 4. FIG. 5 illustrates an example of a relatively high flow rate.

As illustrated in FIG. 5, when the frequency (e.g., the frequency at a point indicated by symbol A in FIG. 5) converted by the inverter 10 is higher than a frequency (e.g., the frequency at a point indicated by symbol B in FIG. 5) specified by the pipe resistance characteristics and the torque curve of the motor 31, the medium control part 22 lowers the frequency of the inverter 10 from Fa to Fb by ΔF so as to reduce the flow rate of the fluid.

When the state of the load such as the mold tool varies so that the flow rate of the liquid increases as indicated by symbol A in FIG. 5 as an example, the pressure and the flow rate of the liquid satisfy the pipe resistance characteristics but the frequency of the inverter 10 and the torque of the motor 31 exceed the torque curve to be used. Thus, in a state that the pressure and the flow rate of the water satisfy the pipe resistance characteristics (in a state of transition from symbol A to symbol B), the frequency of the inverter 10 is lowered and thereby the flow rate of the water is reduced so that control is performed such that the frequency of the inverter 10 and the torque of the motor 31 may fall on the torque curve to be used. Thus, in the conventional art, since the flow rate of the pipe was not allowed to be recognized, the use was to be performed in a state that the valve provided in the pipe was throttled and hence the pipe resistance was increased so that the flow rate was reduced more than an appropriate extent. However, in the present embodiment, even when the state of the load such as the mold tool varies, the flow rate of the water is allowed to be controlled at a highest capability of the motor 31 so that the flow rate having increased is allowed to be reduced. Further, also the adjustment valve for adjusting the flow rate of the pipe 5 may be not provided.

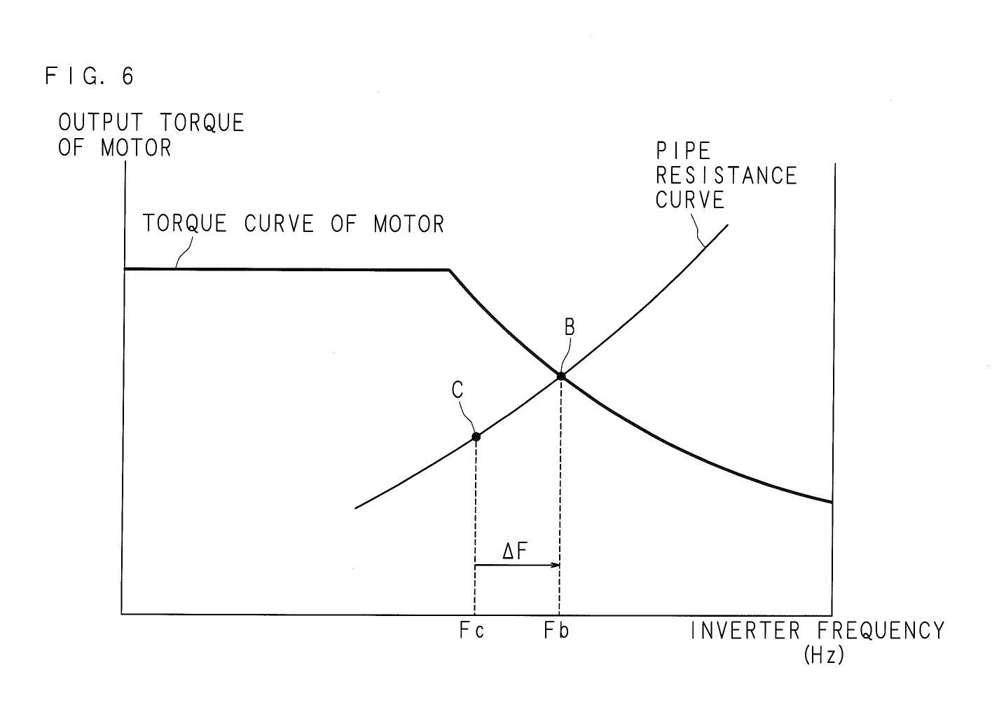

FIG. 6 is an explanation diagram illustrating a second example of flow rate control by the liquid supply apparatus 100 of the present embodiment. The torque curve and the pipe resistance curve in FIG. 6 are similar to those of FIG. 5. As illustrated in FIG. 6, when the frequency (e.g., the frequency at a point indicated by symbol C in FIG. 6) converted by the inverter 10 is lower than a frequency (e.g., the frequency at a point indicated by symbol B in FIG. 6) specified by the pipe resistance characteristics and the torque curve of the motor 31, the medium control part 22 raises the frequency of the inverter 10 from Fc to Fb by AF so as to increase the flow rate of the fluid.

When the state of the load such as the mold tool varies so that the flow rate of the water decreases as indicated by symbol C in FIG. 6 as an example, the pressure and the flow rate of the water satisfy the pipe resistance characteristics but the frequency of the inverter 10 and the torque of the motor 31 go below the torque curve to be used. Thus, in a state that the pressure and the flow rate of the water satisfy the pipe resistance characteristics (in a state of transition from symbol C to symbol B), the frequency of the inverter 10 is raised and thereby the flow rate of the water is increased so that control is performed such that the frequency of the inverter 10 and the torque of the motor 31 may fall on the torque curve to be used. By virtue of this, even when the state of the load such as the mold tool varies, the flow rate of the water is allowed to be controlled at a highest capability of the motor 31 so that the flow rate having decreased is allowed to be increased.

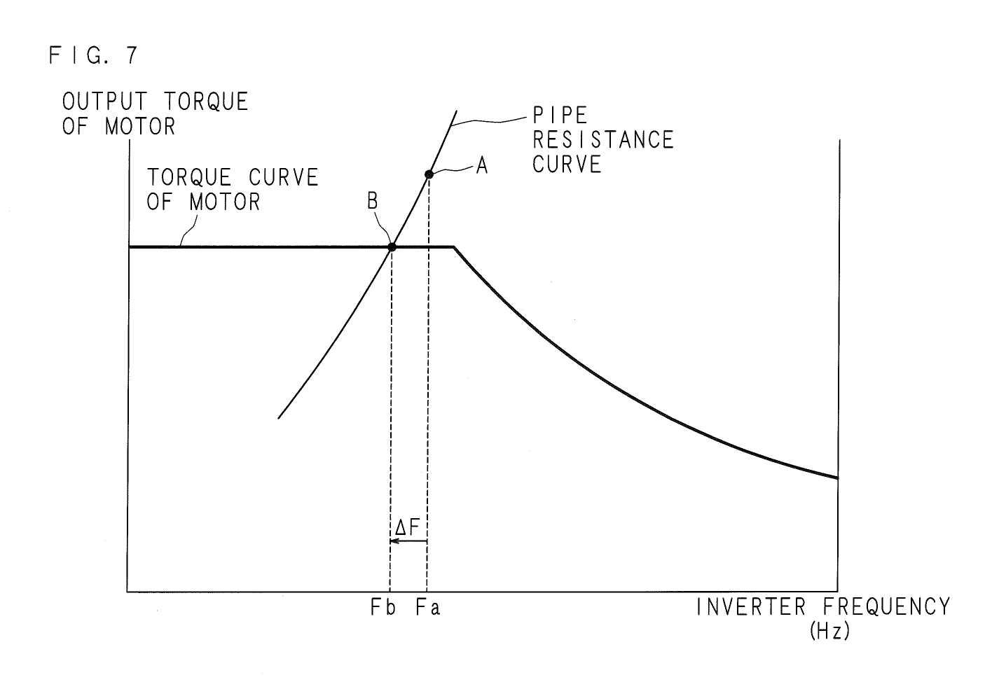

FIG. 7 is an explanation diagram illustrating a first example of pressure control by the liquid supply apparatus 100 of the present embodiment. The torque curve in FIG. 7 is similar to that of FIG. 5.

Further, the pipe resistance curve in FIG. 7 illustrates an example that the pressure is relatively high among the pipe resistance characteristics illustrated in FIG. 4.

When the torque or the torque current of the motor 31 detected by the physical quantity detection part 21 is higher than a given threshold (e.g., at a point indicated by symbol A in FIG. 7, the torque of the motor 31 exceeds the torque curve), the medium control part 22 lowers the frequency of the inverter to a frequency specified by the pipe resistance characteristics and the torque curve of the motor 31 from Fa to Fb by AF and thereby reduces the pressure of the fluid.

When the state of the load such as the mold tool varies so that the pressure of the water increases as indicated by symbol A in FIG. 7 as an example, the pressure and the flow rate of the water satisfy the pipe resistance characteristics but the frequency of the inverter 10 and the torque of the motor 31 exceed the torque curve to be used. Thus, in a state that the pressure and the flow rate of the water satisfy the pipe resistance characteristics (in a state of transition from symbol A to symbol B), the frequency of the inverter 10 is lowered and thereby the flow rate of the water is reduced so that the pressure of the water is reduced on the basis of the pipe resistance characteristics. Since the pressure of the water decreases, the torque of the motor 31 also decreases so that control is performed such that the frequency of the inverter 10 and the torque of the motor 31 fall on the torque curve (a point indicated by symbol B in FIG. 7). Thus, in the conventional art, a bypass passage (a bypass route) was to be provided that, when the state of the load such as the mold tool varies, releases the pressure in order to avoid a situation that the pressure in the pipe becomes of high pressure. However, in the configuration of the present embodiment, even when the state of the load such as the mold tool varies, a situation is avoided that the pressure of the water becomes excessively high. Thus, the bypass passage may be not provided.

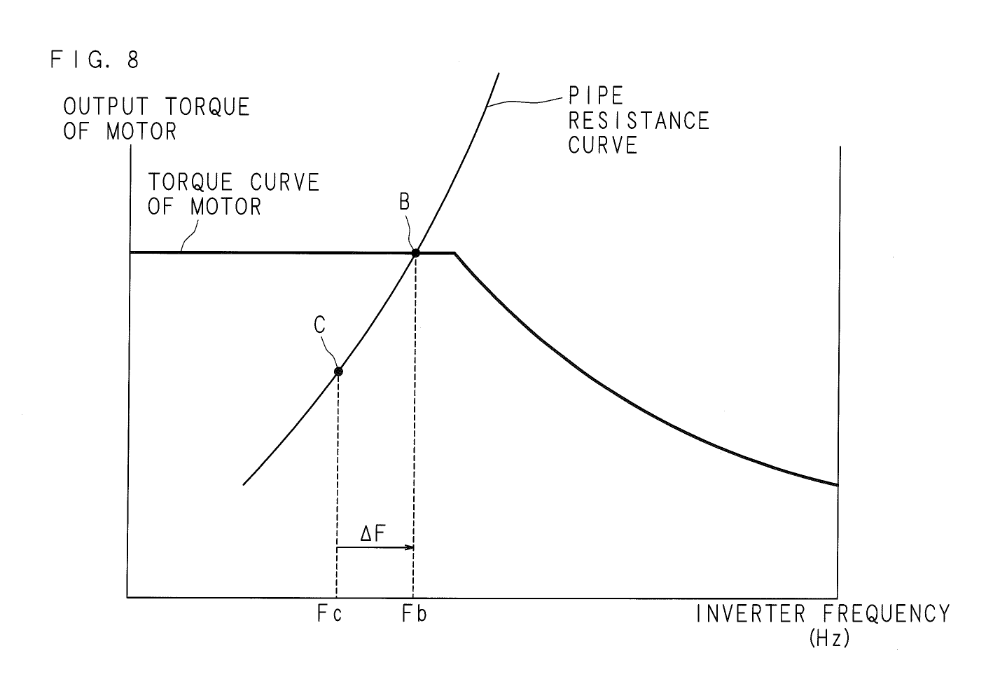

FIG. 8 is an explanation diagram illustrating a second example of pressure control by the liquid supply apparatus 100 of the present embodiment. The torque curve and the pipe resistance curve in FIG. 8 are similar to those of FIG. 7. As illustrated in FIG. 8, when the frequency (e.g., the frequency at a point indicated by symbol C in FIG. 8) converted by the inverter 10 is lower than a frequency (e.g., the frequency at a point indicated by symbol B in FIG. 8) specified by the pipe resistance characteristics and the torque curve of the motor 31, the medium control part 22 raises the frequency of the inverter 10 from Fc to Fb by AF so as to increase the flow rate of the fluid.

When the state of the load such as the mold tool varies so that the flow rate of the water decreases as indicated by symbol C in FIG. 8 as an example, the pressure and the flow rate of the water satisfy the pipe resistance characteristics but the frequency of the inverter 10 and the torque of the motor 31 go below the torque curve to be used. Thus, in a state that the pressure and the flow rate of the water satisfy the pipe resistance characteristics (in a state of transition from symbol C to symbol B), the frequency of the inverter 10 is raised and thereby the flow rate of the water is increased so that control is performed such that the frequency of the inverter 10 and the torque of the motor 31 may fall on the torque curve to be used. Further, when the torque of the motor 31 increases, the pressure of the water supplied by the pump 30 is allowed to be increased. By virtue of this, even when the state of the load such as the mold tool varies, the pressure of the water is allowed to be controlled at a highest capability of the motor 31 so that the pressure having decreased is allowed to be increased.

When a small mold tool is employed in an injection molding machine, the pipeline in the inside of the mold tool is complicated and hence a high pressure loss is caused. There is the tendency that a more complicated structure of the mold tool causes a more complicated structure in the pipeline in the inside of the mold tool and hence a higher pressure loss is caused. Thus, as the pump supplying water to the mold tool, a pump of low flow rate and high pressure is to be employed. Thus, in the conventional art, when the mold tool is changed, the pump is to be changed to a pump of higher pressure. In the present embodiment, since the frequency of the inverter 10 is controlled so that even when the load in the mold tool or the like fluctuates, the flow rate and the pressure of the water supplied by the pump 30 are allowed to be controlled at a highest capability of the motor 31. Thus, for example, even when the mold tool is changed to a much more complicated one, the pump may be not changed to a pump of higher pressure and hence the originally employed pump is allowed to be used intact. Further, according to the present embodiment, the pressure of the pump is allowed to be increased or the flow rate is allowed to be increased. Thus, the heat exchanging performance of the mold tool is allowed to be increased so that the accuracy of the injection molded article is increased and the quality of the molded article is improved.

As described above, according to the liquid supply apparatus 100 of the present embodiment, without changing the pump, the one pump 30 is allowed to supply water to the mold tool or the like from a region of low flow rate to a region of high flow rate. For example, the time and effort of changing the pump when the mold tool is changed is avoided and hence the working efficiency is improved. Further, a situation is avoided that a plurality of pumps are to be prepared in advance. Thus, the fabrication cost such as the equipment cost is allowed to be reduced.

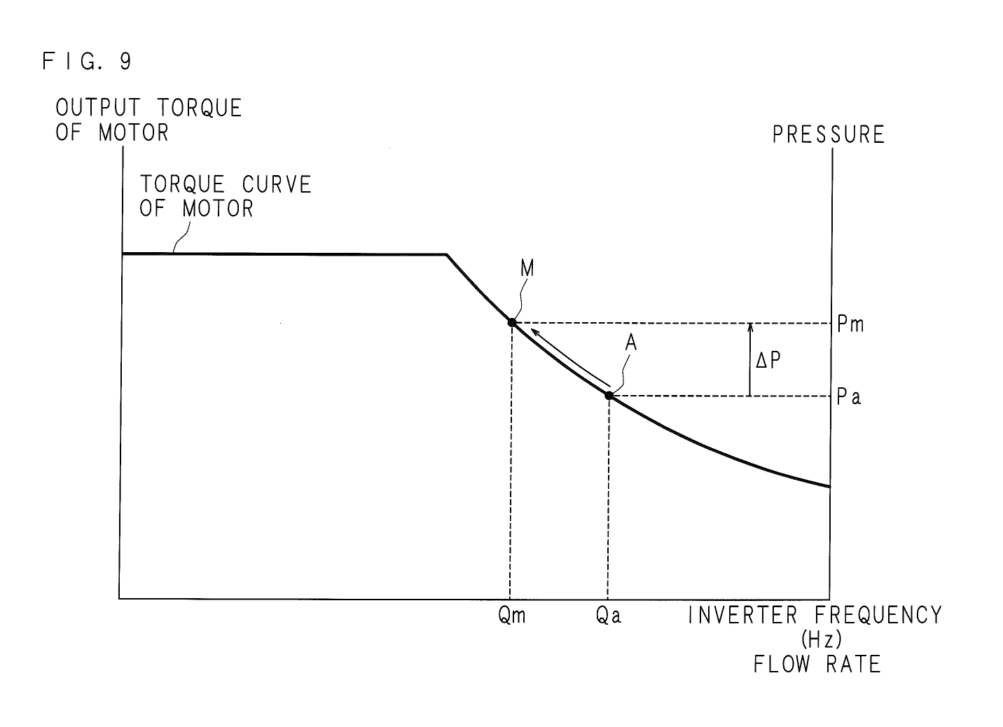

Next, a method of setting the flow rate and the pressure of the water supplied by the pump 30 into desired set-up values is described below. FIG. 9 is an explanation diagram illustrating an example of flow rate setting by the liquid supply apparatus 100 of the present embodiment.

The setting part 24 includes an operation panel or the like, has a function as the flow rate setting part, and then sets up the flow rate value of the water supplied by the pump 30.

The medium control part 22 adjusts the frequency converted by the inverter 10 into a frequency specified by the flow rate (the flow rate Qm corresponding to the point indicated by symbol M in FIG. 9) set up in the setting part 24 and by the torque curve of the motor 31 so as to control the pressure of the fluid. For example, in a case that the state of the load such as the mold tool has varied so that the flow rate of the water has increased to the flow rate Qa specified by point A indicated by symbol A in FIG. 9 as an example, in order that the flow rate may be reduced to the set-up flow rate, the frequency of the inverter 10 is lowered so that the flow rate of the water is brought into the set-up value Qm along the torque curve of the motor 31. By virtue of this, even when the state of the load such as the mold tool varies, control is allowed to be performed such that the flow rate is always maintained at the set-up flow rate. Further, the torque of the motor 31 increases along the torque curve. Thus, when the flow rate of the water is to be reduced to the set-up value, as illustrated in FIG.

9, the pressure of the water is allowed to be increased from Pa to Pm by ΔP.

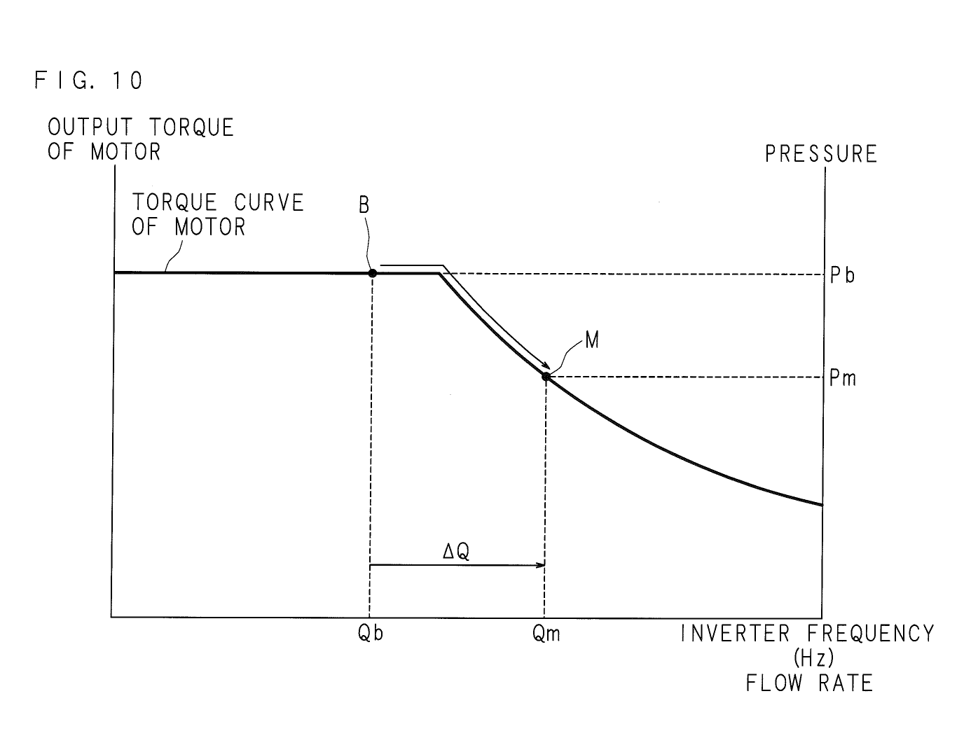

FIG. 10 is an explanation diagram illustrating an example of pressure setting by the liquid supply apparatus 100 of the present embodiment. The setting part 24 has a function as the pressure setting part and then sets up the pressure value of the water supplied by the pump 30.

The medium control part 22 adjusts the frequency converted by the inverter 10 into a frequency specified by the pressure (the pressure Pm corresponding to the point indicated by symbol M in FIG. 10) set up in the setting part 24 and by the torque curve of the motor 31 so as to control the flow rate of the water supplied by the pump 30. For example, in a case that the state of the load such as the mold tool has varied so that the pressure of the water has increased to the pressure Pb corresponding to the point indicated by symbol B in FIG. 10 as an example, in order that the pressure may be reduced to the set-up pressure Pm, the frequency of the inverter 10 is raiseed so that the torque of the motor 31 is reduced along the torque curve of the motor 31 and thereby the pressure of the water is brought into the set-up value Pm. By virtue of this, even when the state of the load such as the mold tool varies, control is allowed to be performed such that the pressure is always maintained at the set-up pressure. Further, the frequency of the inverter 10 is raised. Thus, when the pressure of the water is to be reduced to the set-up value, the flow rate of the water is allowed to be increased from Qb to Qm by ΔQ.

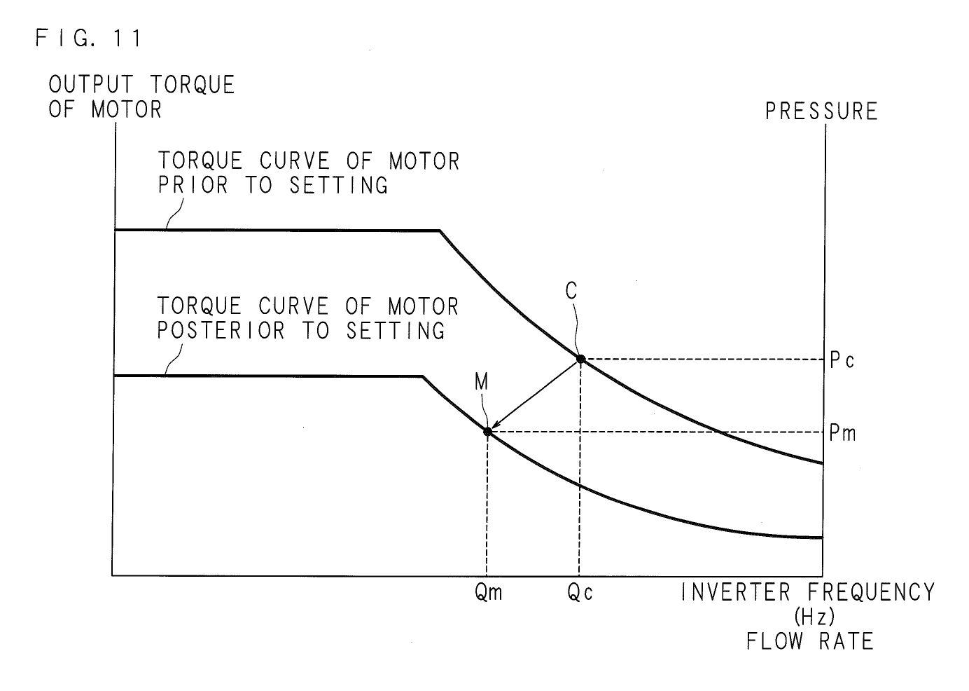

FIG. 11 is an explanation diagram illustrating an example of a case that both of the pressure and the flow rate are set up in the liquid supply apparatus 100 of the present embodiment. The setting part 24 sets up both of the pressure value and the flow rate value of the water supplied by the pump 30.

The medium control part 22 adjusts the frequency converted by the inverter 10 to a frequency specified by the pressure and the flow rate (the pressure Pm and the flow rate Qm corresponding to the point indicated by symbol M in FIG. 11) set up in the setting part 24 and by the torque curve of the motor 31, and thereby controls the flow rate of the water supplied by the pump 30.

For example, in a case that the pump 30 has been operated at the flow rate Qc and the pressure Pc corresponding to the point indicated by symbol C on the torque curve of the motor prior to setting, it is premised that setting is performed such that the pump 30 may be operated at the flow rate Qm and the pressure Pm corresponding to the point indicated by symbol M in FIG. 11. In this case, the medium control part 22 sets up the torque curve of the motor 31 (the torque curve of the motor posterior to setting) such that the frequency converted by the inverter 10 may fall on the point indicated by symbol M on the torque curve. In other words, the torque curve of the motor posterior to setting is adopted as a new torque threshold.

Then, the medium control part 22 lowers the frequency of the inverter 10 and reduces the torque of the motor 31 along the torque curve posterior to setting and thereby performs control such that the flow rate and the pressure of the water supplied by the pump 30 may become equal to the set-up values. The output power (the power consumption) of the motor 31 is proportional to the cube of the revolution rate of the revolving shaft of the motor 31, that is, the cube of the frequency of the inverter 10. Thus, when the frequency of the inverter 10 is lowered in order that the pressure and the flow rate of the water supplied by the pump 30 may become equal to the set-up values, the power consumption is allowed to be reduced remarkably.

Next, display of the pressure and the flow rate of the liquid such as water in the liquid supply apparatus 100 of the present embodiment is described below.

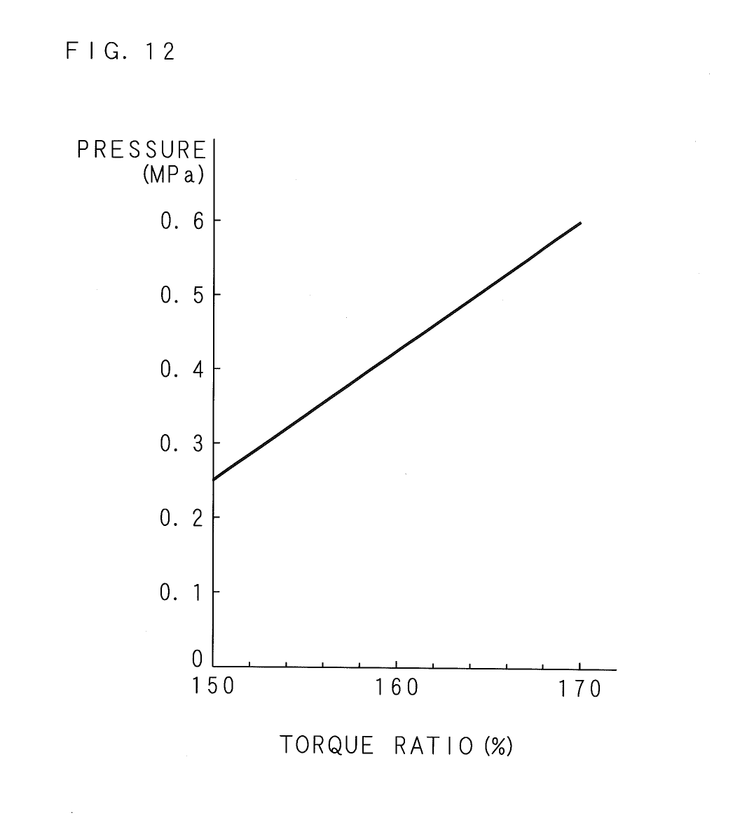

FIG. 12 is an explanation diagram illustrating an example of the relation between the torque ratio of the motor 31 and the pressure of water supplied by the pump 20. The torque ratio is obtained by dividing the actual torque by the rated torque (a fixed value specific to the motor 31) and hence is allowed to be converted into the torque. The pressure P of the water supplied by the pump 30 is in relation of being proportional to the torque ratio R or the torque T of the motor 31. For example, the relation is allowed to be expressed as P=c×R+d or P=c×T+d. The straight line in FIG. 12 illustrates the relation P=c×xR+d. Here, the constants c and d are determined by the specifications or the like of the pump 30, the motor 31, and the like.

As illustrated in FIG. 12, when the torque ratio is 150%, the pressure is approximately 0.25 MPa. When the torque ratio is 170%, the pressure becomes approximately 0.6 MPa. Here, in FIG. 12, when the torque ratio is 150%, the torque is approximately 2.4 Nm and, when the torque ratio is 170%, the torque is 2.7 Nm. The value of the torque over the torque ratio has a specific relation in accordance with the characteristics of the motor 31 and the pump 30. Further, the example of FIG. 12 is illustrative and hence actual situations are not limited to this.

The storage part 23 stores in correspondence to each other the pressure value and the torque ratio or the torque value at a plurality of points on the relational expression indicating the relation between the torque ratio or the torque of the motor 31 and the pressure of the water supplied by the pump 20 illustrated in FIG. 12.

The medium control part 22 has a function as the pressure calculation part and then, on the basis of the relation set forth in advance between the pressure of the water and the torque or the torque current of the motor 31 and on the basis of the torque or the torque current of the motor 31 detected by the physical quantity detection part 21, acquires the torque ratio and then calculates the pressure of the water supplied by the pump 30.

As described above, as for the relation between the pressure of the water and the torque (including the torque ratio) or the torque current of the motor 31, the pressure and the torque or the torque current at a plurality of points on the relational expression indicating the relation between the pressure of the water and the torque or the torque current of the motor 31 may be stored in correspondence to each other in the storage part 23 and then the pressure is allowed to be calculated with reference to the correspondence. Alternatively, the pressure may be calculated by an arithmetic operation based on the relational expression indicating the relation between the pressure of the water and the torque or the torque current of the motor 31.

The display part 25 includes a liquid crystal panel or the like and has a function as the pressure display part. The display part 25 displays the pressure calculated by the medium control part 22. For example, the display part 25 may be constructed such as to display the pressure of the water supplied by the pump 30 in a range of 0 to 2.0 MPa. However, employable configurations are not limited to this. By virtue of this, the pressure gage may be not provided in the pipe through which the liquid flows. Further, an error in pressure measurement caused by use of a pressure gage is avoided and hence the pressure of the liquid is allowed to be acquired accurately.

That is, from the relational expression illustrated in FIG. 12, the medium control part 22 is allowed to calculate the pressure corresponding to the torque of the motor 31 detected by the physical quantity detection part 21 and then the display part 25 is allowed to display the calculated pressure. Thus, a pressure gage may be not provided in the pipe 5.

In the conventional art, for example, when the liquid is to be supplied to the mold tool, the pressure gage is affected by the water supply pressure, the water drainage pressure, and the internal pressure in the inside of the apparatus and hence the discharge pressure of the pump is difficult to be measured by a pressure gage. n order that the discharge pressure of the pump may be read by the pressure gage, the apparatus such as the molding machine is once to be stopped, then start and stop of the pump are to be repeated, and then the difference of the pressure values in the individual cases is to be calculated so that the discharge pressure is to be acquired. Further, when the water is supplied to the tank, a supply water pressure acts. Thus, even if the discharge pressure of the pump were allowed to be measured by a pressure gage, the measured pressure would be in a state of being increased by the supply water pressure and hence the accurate pressure would be difficult to be measured. Further, the pressure gage always receives pressure fluctuation and hence a disadvantage is caused that the lifetime of the pressure gage is short. However, in the present embodiment, the pressure gage may be not provided and hence the problems like in the conventional art are allowed to be solved.

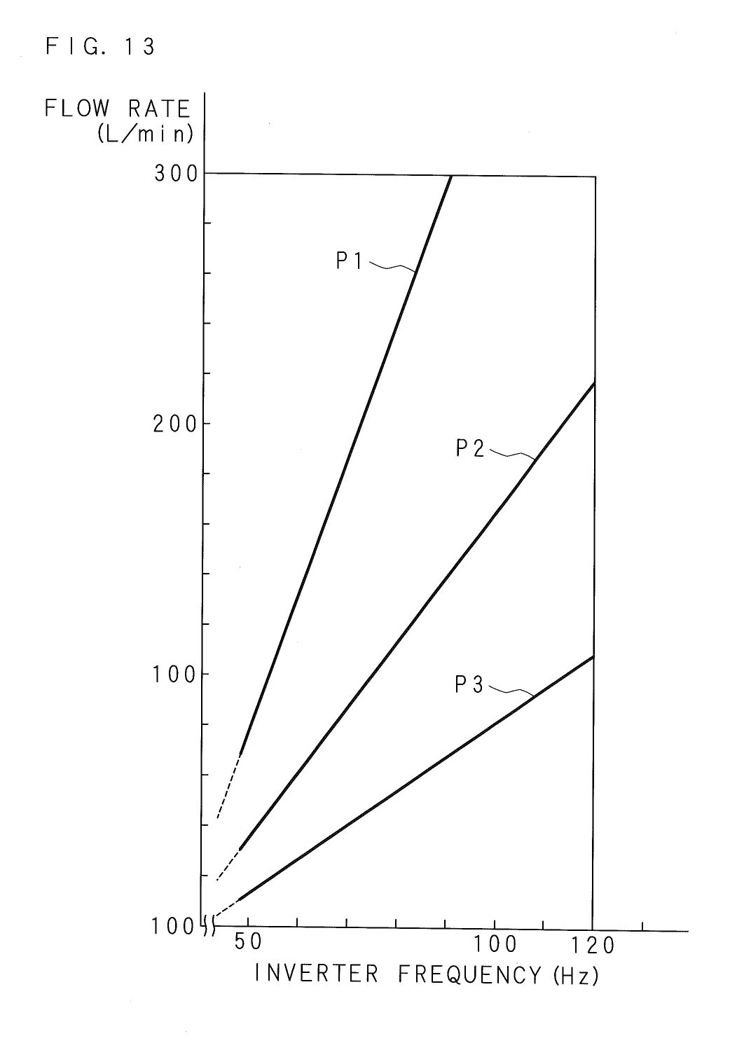

FIG. 13 is an explanation diagram illustrating an example of the frequency of an inverter 10 and the flow rate of water supplied by the pump 30. The flow rate Q of the water supplied by the pump 30 is in relation of being proportional to the frequency F converted by the inverter 10. For example, the relation is allowed to be expressed by Q=a×F+b. The straight line in FIG. 13 illustrates the relation Q=a×F+b. Here, the constants a and b are determined by the specifications or the like of the pump 30, the motor 31, and the like.

In FIG. 13, the straight line indicated by symbol P1 indicates the case of a pump of relatively high flow rate. The straight line indicated by symbol P3 indicates the case of a pump (such as a cascade pump) of relatively low flow rate. The straight line indicated by symbol P2 indicates the case of a pump of medium flow rate. Here, the example of FIG. 13 is illustrative and hence actual situations are not limited to this.

The storage part 23 stores in correspondence to each other the frequency value and the flow rate value at a plurality of points on the relational expression indicating the relation between the frequency of the inverter 10 and the flow rate of the water supplied by the pump 30 illustrated in FIG. 13.

The medium control part 22 has a function as the flow rate calculation part and, on the basis of the relation set forth in advance between the flow rate of the water supplied by the pump 30 and the frequency converted by the inverter 10 and on the basis of the frequency having been converted by the inverter 10, calculates the flow rate of the water supplied by the pump 30.

As for the relation between the flow rate of the water supplied by the pump 30 and the frequency converted by the inverter 10, the flow rate and the frequency of the inverter at a plurality of points on the relational expression indicating the relation between the flow rate of the water and the frequency converted by the inverter 10 may be stored in correspondence to each other in the storage part 23 and then the flow rate is allowed to be calculated with reference to the correspondence. Alternatively, the flow rate may be calculated by an arithmetic operation based on the relational expression indicating the relation between the flow rate of the water and the frequency of the inverter 10.

The display part 25 has a function as the flow rate display part and displays the calculated flow rate. For example, the display part 25 may be constructed such as to display the flow rate of the water supplied by the pump 30 in a range of 0 to 500 L/min. However, employable configurations are not limited to this. Thus, even when an expensive flowmeter is not provided, the flow rate of the water supplied by the pump 30 is allowed to be acquired accurately.

The display part 25 includes a speaker and has a function as the notification part. When the pressure calculated by the medium control part 22 falls outside a given pressure range, the display part 25 notifies this situation. For example, when the pressure of the liquid exceeds the upper limit or goes lower than the lower limit, this situation is allowed to be notified by voice or display.

Further, when the flow rate calculated by the medium control part 22 falls outside a given flow rate range, the display part 25 notifies this situation. For example, when the flow rate of the liquid exceeds the upper limit or goes lower than the lower limit, this situation is allowed to be notified by voice or display.

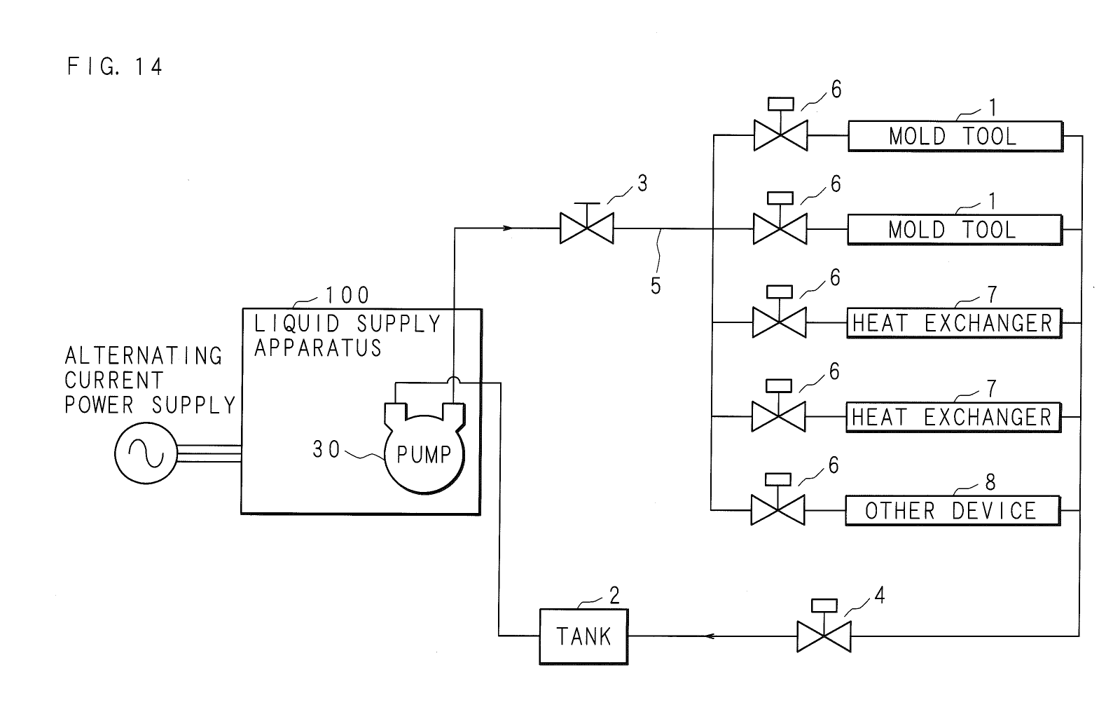

FIG. 14 is an explanation diagram illustrating another example of configuration of the liquid supply system including the liquid supply apparatus 100 of the present embodiment. The difference from the example of FIG. 1 is that a plurality of devices are inserted into the pipe 5. In the example of FIG. 14, two mold tools 1, two heat exchangers 7, and one other device 8 are provided.

Further, an automatic water supply valve 6 is inserted into the pipe connected to each device.

In a system like that illustrated in FIG. 14, each device (the mold tool 1, the heat exchanger 7, or the other device 8) requires the liquid as a medium and the requirement arises irregularly depending on the operating state of the device.

In the liquid supply apparatus 100 of the present embodiment, the flow rate is allowed to be adjusted in a state that the pressure of the liquid supplied by the pump 30 is maintained at constant. Thus, the flow rate required irregularly by each device is allowed to be supplied. For example, in the example of FIG. 14, even when the flow rate of the liquid to the heat exchanger 7 fluctuates, the flow rate and the pressure of the liquid supplied to the mold tool 1 and the other device 8 are allowed to be maintained. By virtue of this, heat exchange in each device is stabilized.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1-14. (canceled)

15. A liquid supply apparatus provided with an inverter converting a frequency of an alternating-current power supply and with a pump including an electric motor driven by the inverter, and thereby supplying a liquid by using the pump, the liquid supply apparatus comprising:
a physical quantity detection part detecting a physical quantity concerning an output of the inverter; and
a medium control part, on the basis of the physical quantity detected by the physical quantity detection part, controlling at least one of a flow rate and a pressure of the liquid supplied by the pump.

16. The liquid supply apparatus according to claim 15, wherein
the physical quantity detection part
is constructed such as to detect at least one of a torque, a torque current, and an electric power of the electric motor.

17. The liquid supply apparatus according to claim 15, wherein
the medium control part
is constructed such as to control a frequency converted by the inverter and thereby control at least one of the flow rate and the pressure of the liquid supplied by the pump.

18. The liquid supply apparatus according to claim 15, wherein
the medium control part
is constructed such as to, on the basis of the physical quantity detected by the physical quantity detection part and pipe resistance characteristics indicating a relation between a frictional resistance and a flow rate of a fluid in a pipeline for supplying the fluid, control at least one of the flow rate and the pressure of the liquid supplied by the pump.

19. The liquid supply apparatus according to claim 18, wherein the medium control part
is constructed such as to control the frequency converted by the inverter,
into a frequency specified by the pipe resistance characteristics and a torque curve of the electric motor and thereby control at least one of the flow rate and the pressure of the liquid supplied by the pump.

20. The liquid supply apparatus according to claim 18, wherein
the medium control part
is constructed such as to, when the frequency converted by the inverter is higher than a frequency specified by the pipe resistance characteristics and the torque curve of the electric motor, lower the frequency of the inverter and thereby reduce the flow rate of the fluid.

21. The liquid supply apparatus according to claim 18, wherein
the medium control part
is constructed such as to, when the frequency converted by the inverter is lower than a frequency specified by the pipe resistance characteristics and the torque curve of the electric motor, raise the frequency of the inverter and thereby increase the flow rate or the pressure of the fluid.

22. The liquid supply apparatus according to claim 18, wherein
the medium control part
is constructed such as to, when the torque or the torque current detected by the physical quantity detection part is higher than a given threshold, lower the frequency of the inverter to a frequency specified by the pipe resistance characteristics and the torque curve of the electric motor and thereby reduce the pressure of the fluid.

23. The liquid supply apparatus according to claim 15, comprising
a flow rate setting part setting up a flow rate of the liquid supplied by the pump, wherein
the medium control part
is constructed such as to adjust the frequency converted by the inverter, into a frequency specified by the flow rate set up by the flow rate setting part and the torque curve of the electric motor and thereby control the pressure of the fluid.

24. The liquid supply apparatus according to claim 15, comprising
a pressure setting part setting up a pressure of the liquid supplied by the pump, wherein
the medium control part
is constructed such as to adjust the frequency converted by the inverter, into a frequency specified by the pressure set up by the pressure setting part and the torque curve of the electric motor and thereby control the flow rate of the fluid.

25. The liquid supply apparatus according to claim 15, comprising:
a pressure calculation part, on the basis of a relation set forth in advance between the pressure of the liquid and the torque or the torque current of the electric motor and on the basis of the torque or the torque current of the electric motor detected by the physical quantity detection part, calculating the pressure of the liquid supplied by the pump; and
a pressure display part displaying the pressure calculated by the pressure calculation part.

26. The liquid supply apparatus according to claim 25, comprising a notification part, when the pressure calculated by the pressure calculation part falls outside a given pressure range, notifying this situation.

27. The liquid supply apparatus according to claim 15, comprising:
a flow rate calculation part, on the basis of a relation set forth in advance between the flow rate of the liquid and the frequency converted by the inverter and on the basis of the frequency converted by the inverter, calculating a flow rate of the liquid supplied by the pump; and
a flow rate display part displaying the flow rate calculated by the flow rate calculation part.

28. The liquid supply apparatus according to claim 27, comprising a notification part, when the flow rate calculated by the flow rate calculation part falls outside a given flow rate range, notifying this situation.
